(19) United States
(12) Patent Application Publication
(10) Pub. No.: US 2021/0046667 A1
(43) Pub. Date: Feb. 18, 2021

(54) LIQUID COLLECTION DEVICE

(71) Applicant: Gongin Precision Industries Co., Ltd., Kaohsiung City (TW)

(72) Inventors: Yo-Hsin SU, Kaohsiung City (TW); Chia-Hao Liu, Kaohsiung City (TW); Hung-Hsiang Lin, Kaohsiung City (TW)

(21) Appl. No.: 16/587,247

(22) Filed: Sep. 30, 2019

(30) Foreign Application Priority Data
Aug. 16, 2019 (TW) 108129283

(51) Int. Cl. B26F 3/00

(52) U.S. Cl. CPC B26F 3/008; B26F 2003/006

(57) ABSTRACT

A liquid collection device is adapted for collecting liquid flowing along a flow path. The liquid collection device includes a collection unit including a top wall member, a bottom wall member, and a surrounding wall member. The top wall member has a liquid inlet extending along the flow path through the top wall member. The bottom wall member is disposed downstream of the top wall member. The surrounding wall member extends from a perimeter of the bottom wall member toward the top wall member. The top wall member covers the surrounding wall member, and cooperates with the bottom wall member and the surrounding wall member to define a liquid-holding space therein, the liquid inlet being spatially communicated to the liquid-holding space.

### CROSS-REFERENCE TO RELATED APPLICATION

This application claims priority of Taiwanese Invention Patent Application No. 108129283, filed on Aug. 16, 2019.

### FIELD

The disclosure relates to a liquid collection device, more particularly to a liquid collection device for a water jet.

### BACKGROUND

For most industrial cutting techniques, thermal energy is generated from interaction between the cutter and the object-to-be-cut. This causes the temperature of the object-to-be-cut to rise and could lead to a change in its chemical properties. As such, a water jet cutting technique, where the thermal energy produced may be carried away by a jet of liquid, is popular. However, if the liquid that carries the thermal energy is not properly processed, it may contribute to a dirty environment.

Referring to FIG. 1, a conventional liquid collection device includes a basin 92 placed beneath the object-to-be-cut 91, the basin 92 being used to collect freefalling liquid 93 so that the freefalling liquid 93 does not spill everywhere. However, considering that the freefalling liquid 93 is in a state of high speed and high pressure, when the freefalling liquid 93 comes into contact with the liquid 93 held in the basin 92, liquid may splash upward to the object-to-be-cut 91 or mechanical components, creating mess and increasing risk of rust developing on the mechanical components.

### SUMMARY

Therefore, the object of the disclosure is to provide a liquid collection device that can alleviate the drawbacks of the prior art.

According to the disclosure, a liquid collection device is adapted for collecting liquid flowing along a flow path. The liquid collection device includes a collection unit including a top wall member, a bottom wall member, and a surrounding wall member.

The top wall member has a liquid inlet extending along the flow path through the top wall member. The bottom wall member is disposed downstream of the top wall member. The surrounding wall member extends from a perimeter of the bottom wall member toward the top wall member.

The top wall member covers the surrounding wall member, and cooperates with the bottom wall member and the surrounding wall member to define a liquid-holding space therein, the liquid inlet being spatially communicated to the liquid-holding space.

### BRIEF DESCRIPTION OF THE DRAWINGS

Other features and advantages of the disclosure will become apparent in the following detailed description of the embodiment with reference to the accompanying drawings, of which:

FIG. 1 is a schematic view of a conventional liquid processing method;

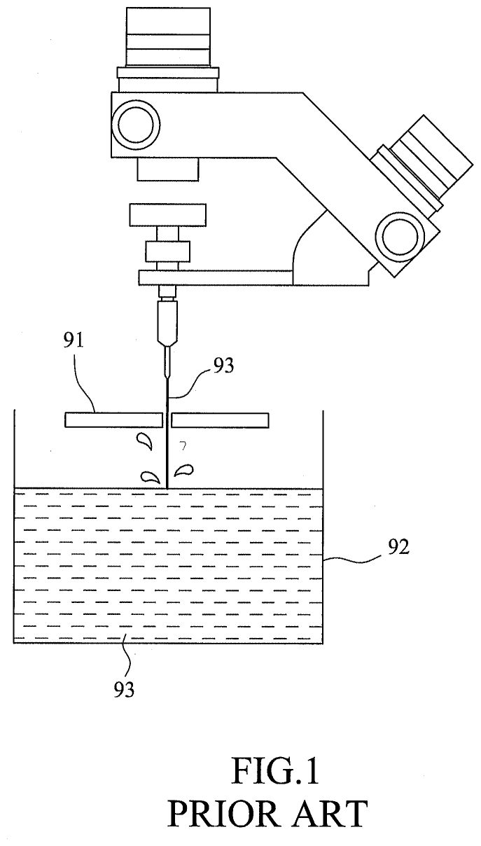

FIG. 2 is an exploded perspective view of an embodiment of a liquid collection device according to the disclosure;

FIG. 3 is a schematic view illustrating a mechanism of liquid collection of the embodiment; and

FIG. 4 is a schematic view illustrating a blocking member of the embodiment decreasing momentum of liquid.

### DETAILED DESCRIPTION

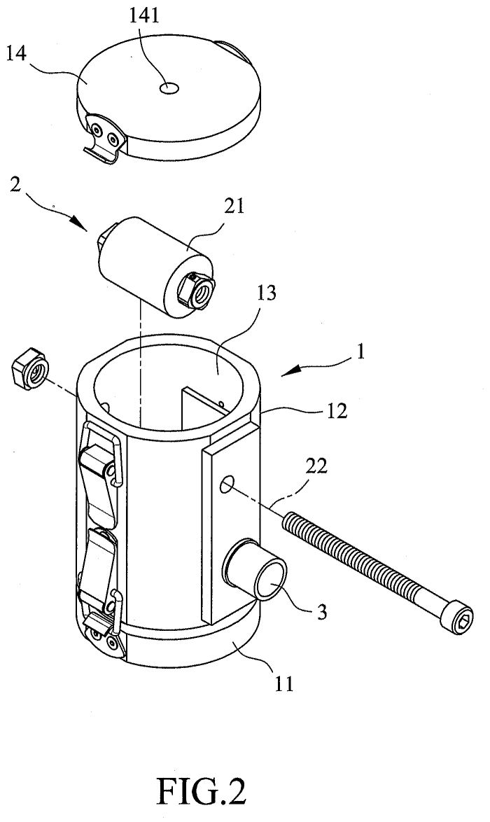

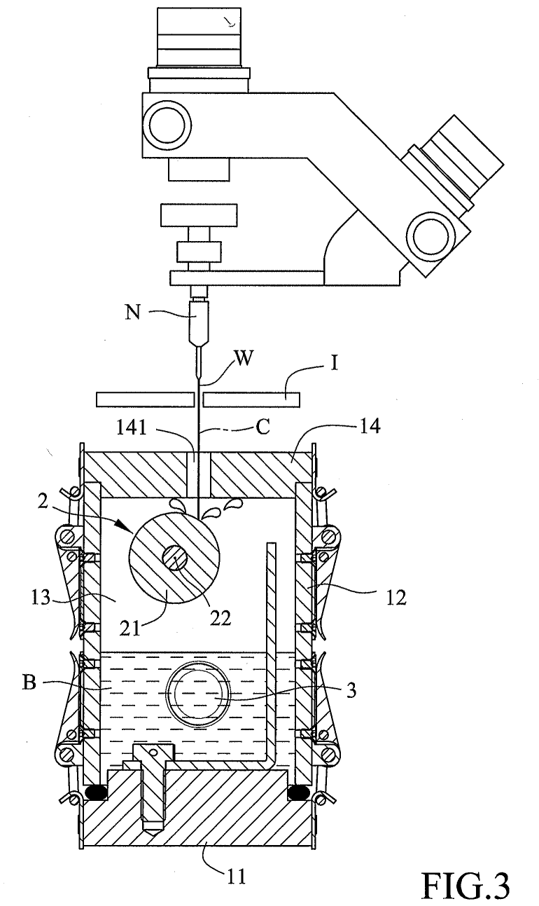

Referring to FIGS. 2 and 3, an embodiment of a liquid collection device is adapted for collecting liquid (W) flowing along a flow path (C). The liquid collection device includes a collection unit 1, a buffer unit 2 and a drainage unit 3.

In this embodiment, the liquid (W) is formed from a jet of water ejected by a nozzle (N) along the flow path (C) to cut an object (I), hence the liquid (W) has high speed and high pressure.

The collection unit 1 includes a bottom wall member 11 disposed in the direction where the liquid (W) flows, a surrounding wall member 12 extending from a perimeter of the bottom wall member 11 upward, and a top wall member 14. The top wall member 14 removably covers the surrounding wall member 12, and cooperates with the bottom wall member 11 and the surrounding wall member 12 to define a liquid-holding space 13 therein. In this embodiment, the surrounding wall member 12 extends from the perimeter of the bottom wall member 11 toward the top wall member 14. The top wall member 14 has a liquid inlet 141 extending along the flow path (C) through the top wall member 14. The liquid inlet 141 is spatially communicated to the liquid-holding space 13. The bottom wall member 11 is disposed downstream of the top wall member 14. It should be noted that in order to effectively collect the liquid (W) , the collection unit 1 should be moved such that the liquid inlet 141 remains aligned with the nozzle (N) .

The buffer unit 2 is mounted in the liquid-holding space 13 and includes a blocking member 21 which is disposed in the flow path (C) for blocking the liquid (W) . In this embodiment, the blocking member 21 is a cylinder which is disposed along an axis 22 that is spaced apart from the flow path (C) . The blocking member 21 surrounds the axis 22 of the buffer unit 2 and is rotatable about the axis 22. In one embodiment, the flow path (C) and the axis 22 are two skew lines in space, so the liquid (W) flowing along the path (C) and hitting the blocking member 21 is able to produce torque for bringing the blocking member 21 to rotation. As the collection unit 1 and the blocking member 21 are exposed to a humid environment for long periods of time and need to sustain impact from the high speed and high pressure liquid (W), materials of the collection unit 1 and the blocking member 21 should be rust and corrosion resistant and have high hardness.

The drainage unit 3 is mounted to the surrounding wall member 12 of the collection unit 1 for draining the liquid (W) stored in the liquid-holding space 13. The drainage unit 3 drains the liquid (W) via vacuum-based draining process.

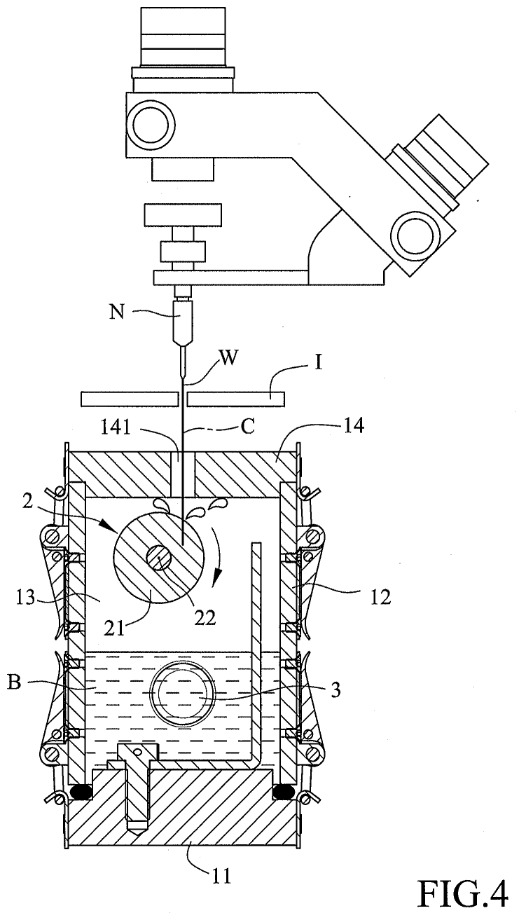

Referring to FIGS. 3 and 4, when the jet of water has been used to cut the object (I) and forms the liquid (W), the liquid (W) is in a state of high speed and high pressure and hence continues moving along the flow path (C). In this embodiment, the liquid inlet 141 is disposed along the flow path (C) such that the liquid (W) may enter the liquid-holding space 13 through the liquid inlet 141. Even if the liquid (W) bounces off the bottom wall member 11 upwards, the top wall member 14 would most likely block the liquid (W) so that it does not exit the liquid-holding space 13.

The disposition of the buffer unit 2 and the formation of a buffer liquid (B) by the liquid (W) in the liquid-holding space (13) may prevent the liquid (W) from bouncing off the bottom wall member 11 and exiting the liquid-holding space 13 through the liquid inlet 141. As the axis 22 of the blocking member 21 is spaced apart from the flow path (C) , the flow path (C) is not perpendicular to a surface of a portion of the blocking member 21 at which the liquid (W) hits the blocking member 21. Therefore, when the liquid (W) flows along the flow path (C) to collide with the blocking member 21, the liquid (W) deflects off the blocking member 21 at an angle to the flow path (C) (see FIG. 3) and deviates from the flow path (C) . Since the liquid inlet 141 is disposed along the flow path (C) , the deviated liquid (W) will be blocked by the top wall member 14 instead of exiting the liquid-holding space 13 through the liquid inlet 141.

Referring to FIG. 4, when the object (I) is of a higher hardness, a stronger strength of the jet of water is necessary, and hence the liquid (W) produced is also of stronger strength. If the higher strength liquid (W) has eroded into the blocking member 21, when the liquid (W) collides with the blocking member 21, the momentum of the liquid (W) is reduced by being transferred to the blocking member 21 in the form of torque which causes the blocking member 21 to rotate about the axis 22. In a case where the liquid (W) is of such high strength that the liquid (W) erodes the blocking member 21 to a point where the blocking member 21 is no longer usable, the top wall member 14 may be uncovered from the surrounding wall member 12 to easily replace the blocking member 21.

The liquid (W) will also be slowed down when it comes into contact with the buffer liquid (B) before colliding with the bottom wall member 11. This not only lowers the possibility of the liquid (W) being deflected to exit through the liquid inlet 141, but also lowers the impact of the liquid (W) on the bottom wall member 11. The liquid (W) then adds to the buffer liquid (B).

The drainage unit 3 drains the buffer liquid (B) via the vacuum-based process as the water level of the buffer liquid (B) rises so that the liquid collection device does not need to be moved to drain the buffer liquid (B).

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A liquid collection device adapted for collecting liquid flowing along a flow path, said liquid collection device comprising:
a collection unit including
a top wall member that has a liquid inlet extending along the flow path through said top wall member,
a bottom wall member that is disposed downstream of said top wall member, and
a surrounding wall member that extends from a perimeter of said bottom wall member toward said top wall member,
where said top wall member covers said surrounding wall member, and cooperates with said bottom wall member and said surrounding wall member to define a liquid-holding space therein, said liquid inlet being spatially communicated to said liquid-holding space.

2. The liquid collection device as claimed in claim 1, further comprising a buffer unit mounted in said liquid-holding space and including a blocking member for blocking the liquid.

3. The liquid collection device as claimed in claim 2, wherein said blocking member of said buffer unit is disposed along an axis that is spaced apart from the flow path.

4. The liquid collection device as claimed in claim 3, wherein said blocking member of said buffer unit surrounds said axis of said buffer unit and is rotatable about said axis.

5. The liquid collection device as claimed in claim 1, further comprising a drainage unit mounted to said surrounding wall member of said collection unit for draining the liquid stored in the liquid-holding space.

6. The liquid collection device as claimed in claim 5, wherein said drainage unit drains the liquid via vacuum-based draining process.

7. The liquid collection device as claimed in claim 1, wherein said top wall member removably covers said surrounding wall member.
